(19) United States
(12) Patent Application Publication
(10) Pub. No.: US 2004/0243389 A1
(43) Pub. Date: Dec. 2, 2004

(54) Method and apparatus for selecting symbols in ideographic languages

(76) Inventors: Ronald Howard Thomas, Bridgeman Downs (AU); Gregory John Litster, Newstead (AU); Russell Jeffrey Taylor, Morningside (AU)

Correspondence Address: SACCO & ASSOCIATES, PA, P.O. BOX 30999, PALM BEACH GARDENS, FL, 33420-0999, US

(21) Appl. No.: 10/486,092

(22) PCT Filed: Aug. 8, 2002
(86) PCT No.: PCT/AU02/01063

(30) Foreign Application Priority Data
Aug. 8, 2001 (AU) PR 6877

(51) Int. Cl. G06F 17/20

(52) U.S. Cl. 704/1

(57) ABSTRACT

Method of and apparatus for selecting one or more characters of an ideographic language including: data processing means operatively associated with data storage means, display means, and a plurality of selection means; the data storage means being operable for storing image data representing a plurality of images corresponding to the characters and selection data corresponding to a sequence of indicia belonging to a predetermined set of indicia for identifying each character, the selection means being operatively arranged in a fixed spatial relationship with one another and each being operable for selecting one of the indicia or one of the characters, the display means being operable for displaying symbols corresponding to the indicia and a predetemined number of the characters corresponding to the image data in a format which mimics the fixed spatial relationship of the selection means; the data processing means being operable to select a set of indicia and the characters for display on the display means, the characters being selected in accordance with a predetermined identification strategy, whereby, in use, the selection of a sequence of indicia causes the display of a set of characters for selection into a word processing document, the selection changing for each indicium selected in turn until the desired character is displayed on the display means.

### FIELD OF INVENTION

This invention relates to a method of and apparatus for selecting symbols in ideographic languages. The invention has particular application to the selection of Chinese language symbols for word processing on a computer. However, it will be appreciated that the invention has general application to ideographic languages in which the characters are formed from strokes or similar formations performed in a set or preferred order, and is not limited to word processing as such.

### BACKGROUND ART

Chinese and other ideographic languages typically have a large number of different symbols or characters which has resulted in the automation of readable forms of such languages being somewhat limited. Many ideographic languages, and particularly Chinese, require the symbols to be formed, when drawn by hand, by performing one or more brush or pen strokes in a strictly observed set order. In the Chinese language, for example, the Chinese Government has compiled an official document setting out the accepted Chinese language wordstock of symbols together with the brush or pen stroke order required to produce the characters. A “brush stroke” in the context of forming a Chinese character is taken to mean, in traditional Chinese calligraphy, the making a mark by a brush from making contact of the brush with the surface to be marked to the breaking of the contact with the surface, and may include moving the brush with respect to the surface, and may further include moving the brush with respect to the surface in more than one direction, such as causing the mark to turn a corner from one direction to another.

The traditional way of learning to read ideographic languages often involves categorizing each character according one or more portions, in the case of Chinese referred to as radicals, and then learning the characters involving each radical, although some characters may be comprised entirely by one radical. Normally, students of ideographic languages are taught to read the language at least to a basic level prior to learning to write the language. Accordingly, when attempts have been made to automate the character selection process, the system of Chinese radicals (or similar concepts in other ideographic languages) have been used on the basis that the selection process should be similar to the reading process.

Early attempts at providing “Chinese word processors” typically involved automating the traditional system of Chinese character selection, involving the selection firstly of “radicals”, and then selecting characters from a range of characters containing such radicals. Alternative, systems requiring selection from a range of phonemes, forming a proposed character on a digitizing pad have also been provided. Such systems often result in the selection process being slow and complicated, and the phoneme system in particular has a further problem in that Chinese writing represents many spoken dialects and a few quite distinct spoken languages, including, for example, Cantonese and Mandarin. Attempts to use character formation methods have also been proposed. Such methods involve the use of a digitizing pad upon which the user is required to form the Chinese character by hand, and the computer is then used to match the hand-formed character with a character from a set which has been stored in the computer. The character matching process was based upon the shape of the character alone once the character had been completely formed, and was slow and unreliable.

In U.S. Pat. No. 4,531,119 a method of and apparatus for key-inputting Chinese and Japanese ideograms called kanji is disclosed in which the operator keys in a kana reading using a keyboard having character keys for entering the kana reading. Candidate kanji characters are displayed on a computer screen and the operator selects on of the displayed candidate kanjis which meets the operator's intention. Hiragana or katakana is selected for typing directly into text by pressing either of two keys allocated from the keyboard to that purpose. To type kanji, a “kanji” key is first pressed and the readings of the desired kanji are typed. After typing the kana for the kanji character, a “choice” key is pressed, and the most common eight kanji for the inputted reading are displayed on the display screen in a configuration representing the keyboard keys for UIOP and JKL+(the “+” being alongside the “L” where the colon is normally located on a western keyboard). One of the displayed kanji is selected by pressing a key on the real keyboard in the same relative position as the on-screen kanji.

In U.S. Pat. No. 4,937,745, a method of and apparatus for selecting and storing “script” characters is disclosed which uses a specially adapted light-pen to point to “BoPoMoFo phonetic units”, or “strokes” are entered using the pen, and the screen updates to show an array of characters. The light-pen is provided with selection switches for selecting a desired character. In U.S. Pat. No. 5,128,672, a keyboard is disclosed for predictively displaying different character layouts based upon the last character entered by the user from the user or an insertion point is entered in a corresponding text field on a display. The main purpose of the invention disclosed therein is to reduce the number of keys on the keyboard, and accordingly, thirteen letters or symbols are displayed among fifteen keys depending on the last character entered, or the last character preceding an operator-selected insertion point. A “flip” key is used to display another set of thirteen letters. Four different screens are necessary to enable text entry in English (comprising capitals and lower case English alphabet characters) and a further four screens are required for numbers and symbols.

In U.S. Pat. No. 5,187,480, (the '480 patent) a system for selecting ideographic language characters is described based upon the method of writing the characters rather than the method of reading and understanding the meaning of such characters to make the selection. The invention described in the '480 patent involved a new selection criterion for Chinese language characters in particular and ideographic languages in general. Rather than relying on the traditional teachings concerning learning to read Chinese characters as well as to form the characters by hand, a simplified system is taught which relies firstly on the size of the brush or pen stroke and secondly on the initial one or two directions each brush stroke followed when forming the character. As taught in the '480 patent, the size is taken to be either a dot, or larger than a dot, and the direction is taken to be either no direction at all (as in the case of a dot), or the initial one or two directions followed in performing a brush stroke.

According to the '480 patent, in the Chinese language this system may, for example, be reduced to five categories of brush stroke comprising:

(1) the “di\check{a}n” (meaning “dot”, “drop” or “speck”);

(2) the “héng” (meaning “horizontal”, “across” or “sideways” and which is formed from left to right);

(3) the “shù” (representing a vertical stroke downwards);

(4) the “piê” (representing an oblique stroke downwards from right to left); and

(5) the “nà” (representing an oblique stroke downwards from left to right).

This system may involve three further categories in which the héng, shù and piê are supplemented by the héngje, shùje and piêje in which the brush strokes proceeded in a further direction. If desired, two further sub-categories may be defined such as, for example, the characters and radicals “zh\overline{i}” and “le” where the brush stroke follows a third direction after the first two. In such a system of character input, the user is required to mentally categorize at least the initial strokes according to the initial directions which would be followed if the strokes were to be formed by hand.

Using the system of categorizing brush strokes according to size and direction, and then allocating the categories to the dot, and the initial one or two directions only, Chinese characters could be categorized into eight brush-stroke categories, and this system has been implemented on popular computer platforms in what has become known as the “Chinese simplified stroke input method”. The simplified stroke input method has been found to be useful, and it has been found in practice to require an average of 2.9 key strokes to retrieve a Chinese character.

In the '480 patent, a number of characters are displayed on a computer screen and means is provided for selecting one of the characters for entry into a body of ideographic language text. In its preferred form, the characters for selection are provided in the form of a quincunx of the five most likely characters to be used according to the frequency of usage of the characters of the language.

In U.S. Pat. No. 5,319,386, an interactive keyboard and display apparatus is disclosed for the entry of ideographic characters in a computer or the like. Pressure is applied to cells on the display to update, select and enter characters using any convenient combination of phonemes, primary strokes, priary radicals or the like. Different combinations of these are used until the number of displayed characters is reduced to one. U.S. Pat. No. 6,002,390 discloses a pen-input computer programmed to display kana readings according to Japanese syllabary for selection using a light-pen. Pull-down or pop-up menus are displayed showing candidate words for selection according to the most likely word according to selection criteria based upon the most common words following the previously entered sentence.

The present invention aims to provide a method of and apparatus for selecting symbols in ideographic languages which improves upon known methods. Other aims and advantages of the invention may become apparent from the following description.

### DISCLOSURE OF THE INVENTION

With the foregoing in view, the present invention in one aspect resides broadly in character selection apparatus for selecting one or more characters of an ideographic language including:

data processing means operatively associated with data storage means, display means, and a plurality of selection means;

said data storage means being operable for storing image data representing a plurality of images corresponding to said characters and selection data corresponding to a sequence of indicia belonging to a predetermined set of indicia for identifying each said character;

said selection means being operatively arranged in a fixed spatial relationship with one another and each being operable for selecting one of said indicia or one of said characters;

said display means being operable for displaying symbols corresponding to said indicia and a predetermined number of said characters corresponding to said image data in a format which mimics said fixed spatial relationship of said selection means;

said data processing means being operable to select a set of said indicia and said characters for display on said display means, said characters being selected in accordance with a predetermined identification strategy, whereby, in use, the selection of a sequence of indicia causes the display of a set of characters for selection into a word processing document, the selection changing for each indicium selected in turn until the desired character is displayed on the display means.

Preferably, the data processing means, the display means, and the selection means are provided in the form of a first computer and the data storage means is provided in operative association with a second computer, the strategy for selection of the characters for display being programed into the second computer. More preferably, a plurality of first computers may be operatively connected to the second computer, and one or more of the first computers may be remote from the second computer. For example, the second computer may be in the form of a server computer, and the plurality of first computers may be in the form of a corresponding plurality of client computers. In such form, the server computer may communicate with the client computers using a popular protocol such as transmission control protocol and Internet protocol (TCP/IP) or such like.

In another aspect, the present invention resides broadly in symbol definition apparatus including:

programmable electronic processing means;

dynamic display means operatively associated with or forming part of said programmable electronic processing means, said programmable electronic processing means being programmed to display an array of ideographic symbols selected according to the most likely next symbol or symbols to be required, and

a plurality of selection means operatively associated with or forming part of said programmable electronic processing means, said selection means being arranged in spatial relationship with one another and operable for selecting one or more symbols from said array, and wherein said array mimics the spatial relationship of the selection means.

In another aspect, the present invention resides broadly in a method of selecting ideographic language symbols for input into symbol definition apparatus having programmable electronic processing means, dynamic display means operably associated with or forming part of the programmable electronic processing means and selection means operably associated with or forming part of the programmable electronic processing means, the method including:

programming the programmable electronic processing means to display an array of the ideographic symbols on a portion of the dynamic display means, the ideographic symbols being selected according to the most likely next symbols to be required;

operating said selection means to select one or more symbols.

Preferably, the method includes displaying a new set of symbols on the dynamic display means for each further selection of the one or more ideographic symbols, providing a user again with the most likely next symbols for entry into, for example, a word processing document.

In another aspect, the present invention resides broadly in software for selecting ideographic language symbols including:

a central processing module operable to control operation of the software;

a storage module operably associated with said central processing module and operable to store data relevant to a plurality of ideographic symbols;

a retrieval module operably associated with said central processing module and operable to retrieve data relevant to a selection of at least some of the ideographic symbols from said storage module;

a display module operably associated with the central processing module and operable to display said selection in the form of an array of ideographic symbols, and

a selection module operatively associated with said central processing module and operable to select one or more symbols from said array.

The selection module is preferably associated with selection means, preferably in the form of a keyboard, and is typically a standard computer keyboard operable by depressing selected keys. The array is in the form of a mimic of the keyboard displayed on the dynamic display means, which is preferably in the form of a computer screen. However, it will be appreciated that the selection means may be provided in the form of a touch screen or pointing device.

The modules included in the software described above may be programmed into a general purpose digital electronic computer, or into several electronic computers operatively linked together. Moreover, some of the modules may be programmed into a central computer (a “server computer”) and other modules programmed into other computers (“client computers”) operable to call and execute the modules programmed into the server computer. In such form, the client computers may be programmed only to the extent necessary for the efficient display of selected characters on display means operatively associated with the client computers. For example, the storage of the characters may be centralized on the server computer, and the remainder of the software provided on one or more client computers whereby the client computer(s) may be provided in limited processing capacity, for example, to minimize equipment costs.

In one preferred form, the ideographic language is Chinese and the keyboard is a standard keyboard having a QWERTY portion and a numeric keypad portion. Preferably, the numeric keypad portion is provided with five alternative brush-stroke type categories as follows:

(1) any brush stroke written from left to right without turning, that is the “héng”; the “tí” or rising stroke is included in this category;

(2) any brush stroke written from top to bottom, that is the “shù”; basic strokes having hooks, that is, “shùg\overline{o}u” are included in this category,

(3) all left falling “piê” strokes;

(4) all dots and the right falling “nà”; and

(5) all complicated “fùzá” or bent “zh\overline{e}” strokes turning through more than one direction.

Once these categories are explained to the Chinese literate, it would be quite straightforward to commence entering Chinese characters using the system of the present invention. It will be appreciated that for all characters, the sequence defining each character or word will be of a finite length, and if desired, a highlight or warning means may be provided to indicate to the user if the entire sequence of indicia for one or more characters or words displayed has been defined. Preferably, an audible warning is provided if the sequence entered is not valid for any Chinese character.

In an alternative form, the numeric keypad portion as displayed on the display means may be provided with five ofthe character brush-stroke type categories as set forth in the '480 patent described above and commonly used characters, words, word sequences or phrases may be displayed for selection on the QWERTY portion.

Further alternatives could include, for example, Kanji (Japanese) and Hanja (Korean). Kanji and Hanja characters correspond very closely, if not almost exactly, in stroke construction to Chinese characters. It is also preferred that an option is included to switch the keyboard to an entry device for Kana or Hangul from the QWERTY portion of the keyboard, and then back to Kanji or Hanja respectively as the case may be. (It is to be understood that it would be quite unlikely to switch to between the syllabic version of one language and the ideographic version of another language.) Moreover, the QWERTY portion could be toggled between “simplified” characters of the Peoples Republic of China and the “traditional” characters mainly used in Taiwan, or to use for English or another syllabic language, including, for example, kana or hangul.

In another aspect, the present invention resides broadly in apparatus for selecting symbols of an ideographic language including:

graphic data storage means for storing data representing graphic images of ideographic characters for the ideographic language;

character stroke data storage means for storing data representing stroke order of character strokes required to form said ideographic characters, said character strokes being categorised into a predetermined number of character stroke-type categories;

index means for indexing the data representing stroke order of character strokes against the data representing the graphic images;

display means for displaying one or more ideographic characters retrieved from said graphic data storage means;

character sub-element entry means for entering sub-elements of ideographic characters, said character sub-elements being in the form of said character stroke-type categories;

selection means for selecting one or more of the ideographic characters displayed by the display means;

processing means operatively connected to said graphic data storage means, said character stroke data storage means, said index means, said display means, said entry means and said selection means being operable to identify one or more characters within the character stroke data storage means on entry through the entry of ideographic stroke-type categories and the order in which the character strokes are entered through the entry designations, whereby one or more graphic representations of the ideographic characters indexed according to the character stroke order are retrieved from the corresponding character data storage means according to said index means and the graphic representation or representations are displayed by the display means for selection by said selection means.

Preferably, the character is a Chinese writing character, and the sub-elements are the strokes from which the Chinese character is formed. In such form, it is preferred that the sub--elements are categorized according to stroke size and stroke form, and the indexing means include data relevant to the stroke size, stroke form, the initial direction of writing the strokes, the order in which the strokes are written to form the character, the number of strokes and data related to the frequency of usage of the character and character combinations forming words or phrases. In a further preferred form, the processing means includes provision of undesignated strokes in the sequence of strokes, and being treated as “wildcards” whereby a user may select characters which are not precisely known to the user as to the correct stroke order and/or categories. The selection means may further include a “point and click” device for a computer, such as mouse, digitizing pad, light pen or such like.

### BRIEF DESCRIPTION OF TIRE DRAWINGS

In order that the invention may be more readily understood and put into practical effect, reference will now be made to the accompanying drawings which illustrate a preferred embodiment of the invention, wherein:

FIG. 1 is a diagrammatic representation of an exemplary keyboard array which may be displayed by a computer screen for definition of symbols in accordance with the invention;

FIG. 2 is a diagrammatic representation of the QWERTY portion, display portion and space bar portion of the keyboard of FIG. 1 but having shown thereon twenty-six frequently used characters;

FIG. 3 is a diagrammatic representation of an exemplary keyboard which may be displayed by a computer screen, but corresponding to a keyboard having no numeric keypad, for displaying characters in accordance with the invention;

FIG. 4 illustrates a list of twenty-three basic stroke types which may be used in Chinese writing; and

FIG. 5 illustrates a categorization of the basic stroke types of FIG. 4 into five stroke type categories for use in symbol definition apparatus according to the invention.

### DETAILED DESCRIPTION OF THE DRAWINGS

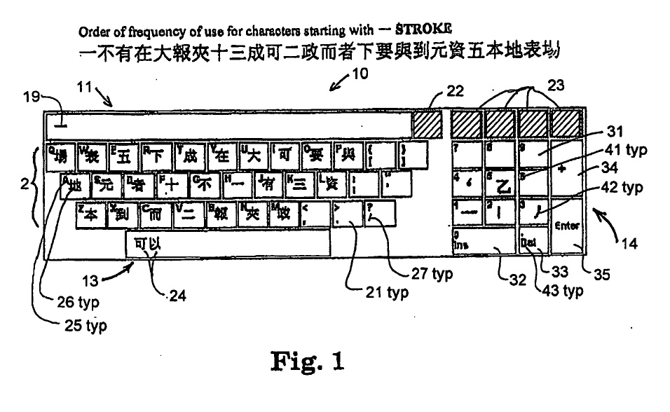

The keyboard display 10 shown in FIG. 1 is laid out as a standard QWERTY keyboard would be laid out, being rectangular in form and includes a dynamic display portion 11 for displaying Chinese characters towards the upper left hand edge of the keyboard display, a QWERTY portion 12 below the display portion, a space bar portion 13 below the QWERTY portion, but not extending to the full width of the QWERTY portion, and a numeric keypad portion 14 to the right of the QWERTY portion and the space bar portion. The display portion extends substantially to the same width of the QWERTY portion, and a shaded pane 22 representing a backspace key is provided to the right of the display portion. The display portion shown has a stroke-type indicium 19 representing the depression of a key to select that particular stroke type category. In the example shown in FIG. 1, a left-to-right stroke-type category is shown as entered.

The QWERTY portion has a plurality of window panes shown typically at 21, the panes being arranged to simulate the layout of the relevant portion of a standard QWERTY keyboard as shown. Each of the panes is substantially square or has a standard key-form aspect ratio and has represented thereon a Roman-type typographical character shown typically at 25 towards the upper left hand corner of the pane, and most of the panes have a Chinese character shown typically at 26 substantially centrally within the pane. Some of the panes also have an alternative Roman-type typographical character towards the lower left hand corner. The panes are arranged in three rows, the upper row having twelve panes, the middle row having eleven panes arranged centrally under the upper row, and the lower row having ten panes arranged centrally under the middle row in accordance with the common standard layout for QWERTY keyboards.

The space bar portion is located substantially centrally below the QWERTY portion, but does not extend to the full width thereof, its left hand extremity ending about 1½ panes inward from the left of the bottom row of panes in the QWERTY portion and its right hand extremity ending about two panes inward from the right of the lower row of panes in the QWERTY portion. The space bar portion has represented thereon a plurality of Chinese characters 24 (a “space character” as such not being required for the construction of Chinese text because Chinese characters are automatically spaced from one another). In the example shown, two characters at 24 are shown as a suggested word, being the most commonly used word written using the left-to-right written stroke. The complete word may be entered into text by pressing the actual keyboard space bar.

The numeric keypad also includes an array of square or rectangular panes 31 arranged in columns and rows below four more blacked out square panes 23 representing four corresponding keys on a typical computer keyboard having a numeric keypad in the layout which is standard for most computer keyboards. Some computer keyboards also have extra “cursor control” keys between the QWERTY portion and the numeric keypad portion, but these are not used or represented in the particular embodiment of the present invention described with reference to FIG. 1. Three of the panes of the numeric keypad are rectangular, being double the size of the other panes 31. A “plus sign” pane 34, and an “enter key” pane 35 are double the height of the other panes 31, and an “insert key” pane is double the width of the other panes 31. In similar fashion to the panes of the QWERTY portion, the panes each have a Roman-type typographical character or word shown typically at 41 located in most instances towards the upper left hand corner of the pane. Most panes also have a Chinese character stroke-type category indicium shown typically at 42 located towards the centre of the pane, and some of the panes have an alternative Roman-type typographical character or word shown typically at 43 towards the lower left hand corner of the pane.

In the particular keyboard display shown, the Chinese characters shown in the various panes are the twenty-six most commonly used characters beginning with the particular indicium 19 shown in the display portion after selection thereof by depressing the “1” key in the numeric keypad portion, in this example, the “héng” stroke-type category. Should none of the twenty-six characters be the required one, a further stroke-type category key may be depressed corresponding to the appropriate indicium or stroke-type category pane on the keyboard display, whereupon the twenty-six most common characters corresponding to the first two stroke-type categories selected are displayed in the order selected, possibly including characters which were not displayed in response to the first stroke-type category selected. The more frequently used characters are disposed towards the centre of the QWERTY portion, such as the positions where the letters “G” or “H” are located on the QWERTY keyboard, and the characters being distributed about the “G” or “H” key such that those characters which are further out from the “G” or “H” keys are less common than those closer to the “G” or “H” keys. If there are less than twenty-six characters for selection according to the stroke-type category sequence entered, the outer panes of the QWERTY portion ofthe keyboard display are left blank. In distributing the characters about the QWERTY portion, consideration may also be given to placing characters which frequently follow one another on adjacent keys so that they may be quickly entered or even learned if repeated with sufficient frequency.

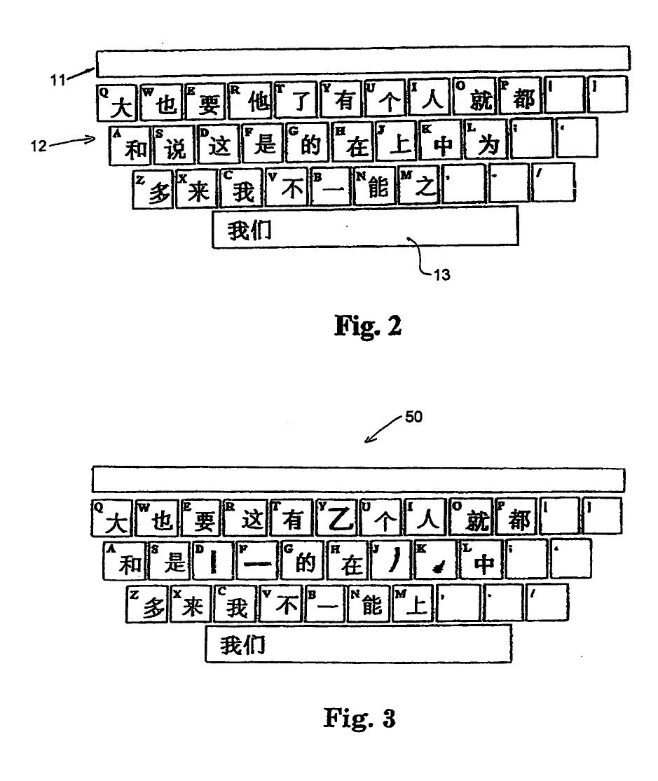

The QWERTY portion of the keyboard display shown in FIG. 2 has the twenty-six most commonly used characters for selection prior to the selection of any stroke-type categories, allowing a user to select a Chinese character without having to enter the entire sequence of indicia or to break it down to its constituent stroke-types.

In one mode of operation, the keyboard display may remain on the screen after character selection, in which case any other character or characters displayed may be selected without further stroke entry, and in which case the delete or backspace key may be used to clear the display portion before resuming stroke or character entry. Alternatively, the keyboard display may be cleared and the initial display such as that shown in FIG. 2 may be displayed after selection of a character.

It is preferred that character selection means functions to select a set of the next most likely characters to be required in the context of the characters already selected in much the same way that the set of characters selected for display on the panes of the QWERTY portion are selected according to the most likely characters according to the initial stroke-type categories. A function key is also provided to allow the user to display the next most likely set of characters having the stroke-type category content and order entered at any stage, and this key may be depressed repeatedly until the desired character is displayed for selection. Continuous analysis of a memory buffer store of the previous character string may be used in aiding the prediction of the next most likely required character or characters, the predicted text being displayed in the space bar portion of the keyboard display, and may be selected by depressing the space bar key on the keyboard. It may be noted that Chinese characters once formed would automatically have the required space provided between them, so that there is normally no need to enter a space character as such. A function key may be provided to be used as a “space” key if desired.

The four extra blacked out panes 23 may be used as function keys for particular purposes, such as, for example, entering predetermined phrases, changing frequency of use information (such as for particular subject matter areas), for switching between character sets or such like.

Should an incorrect key be depressed or an incorrect character be selected, the backspace key may be used for correction purposes. The backspace key also updates the stroke input history and character display. In other words, by using the backspace key, the display and the stroke input history reverts to what was shown prior to the input of the “incorrect” key. Of course, other standard word processing functions may be provided, such as marking, cutting, copying and/or pasting of blocks of text or storage and retrieval of key-stroke sequences, as are commonly provided in word processing software packages in Western languages. It will be appreciated that where a reference is made to a key on a keyboard being depressed, it will be understood that such reference includes the equivalent function of moving a pointing device to cause movement on the display of a pointer or cursor and depressing or clicking a button or the like.

The keyboard display 50 shown in FIG. 3 does not have a numeric keypad, such as is common in the case of laptop type computers. In such form, the panes have stroke-type categories on some of the panes instead of Chinese characters shown in FIGS. 1 and 2. Apart from this, the function of the invention using this embodiment of keyboard display and corresponding keyboard is the same as described with reference to FIGS. 1 and 2.

The keyboard displays described are preferably movable about the computer screen such that the text being input is not obscured by the keyboard display, or they may be moved using the normal window relocation functionality provided with many operating systems using a graphic user interface. Alternatively, the keyboard display may be semi-transparent, or operate in a separate window or skin, or on a separate display or screen.

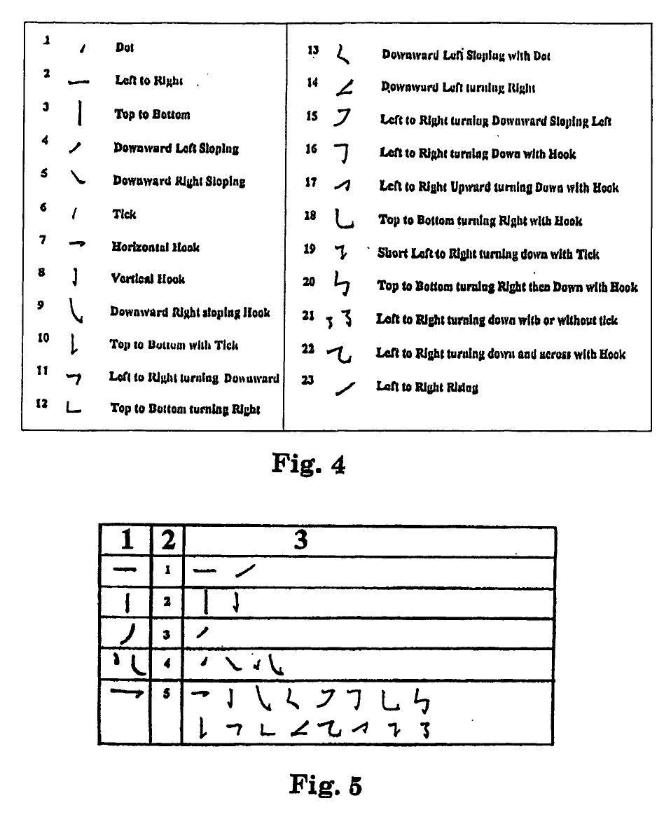

The list shown in FIG. 4 shows the categorization of strokes into twenty-three basic stroke-types according to the official Chinese government stroke-type descriptions. These may be categorized in accordance with the invention into the five categories described above, namely:

(1) the “héng” and the “tí” type strokes;

(2) the “shù” and the “shùg\overline{o}u” type strokes;

(3) the “piê” type strokes;

(4) all dots and the “nà” type strokes; and

(5) the “zh\overline{e}” type strokes.

The basic brush-strokes are allocated to the categories as indicated in FIG. 5, with the basic brush-stroke numbered 8 (the vertical hook—see FIG. 4) being in category (2) (“shùg\overline{o}u”) if a simple hook, but also in category (5) (“zh\overline{e}”) if the brush-stroke continues after the hook. Similarly, the basic brush-stroke numbered 9 (see FIG. 4), the downward right-sloping hook is in category (4) (“nà”) if simply a hook, but also in category (5) (“zh\overline{e}”) if the brush-stroke continues after the hook. It is believed that the alternative stroke-type categories of the present invention provides for a substantial reduction in the number of keystrokes required for redaction of ideographic language text over the invention described in the '480 patent.

It is believed that the alternative stroke-type categories of the present invention provide for a substantial reduction in the number of key strokes required foe ideographic text input. Additionally, use of stroke entry on the numeric keypad with display of up to twenty-six candidate characters on the QWERTY portion of the keyboard allows fast two-handed typing entry, which was not possible in the case of the system taught in the '480 patent because the same hand was taught to be used for both entry and selection.

Although the invention has been described with reference to one or more specific examples, it will be apparent to persons skilled in the art that the invention may be embodied in other forms within the broad scope and ambit of the invention as claimed in the following claims.

1. Character selection apparatus for selecting one or more characters of an ideographic language including:
data processing means operatively associated with data storage means, display means, and a plurality of selection means;
said data storage means being operable for storing image data representing a plurality of images, each of said characters being represented by one or more of said images, and selection data corresponding to a sequence of indicia belonging to a predetermined set of indicia for identifying each said character;
said selection means being operatively arranged in a fixed spatial relationship with one another and each being operable for selecting one of said indicia or one of said characters;
said display means being operable for displaying symbols corresponding to said indicia and said images of a predetermined number of said characters corresponding to said image data in a format which mimics said fixed spatial relationship of said selection means;
said data processing means being operable to select a set of said indicia and images of said characters for display on said display means, said characters being selected in accordance with a predetermined identification strategy, whereby, in use, the selection of a sequence of indicia causes the display of a set of characters for selection into a word processing document, the selection changing for each indicium selected in turn until the desired character is displayed on the display means; and characterized in that;
said data processing means, said display means, and said selection means are provided in the form of a first computer and said data storage means is provided in operative association with a second computer, said strategy for selection of one or more of said characters for display being programmed into the second computer.

2. Character selection apparatus according to claim 1, characterized in that a plurality of first computers is operatively connected to the second computer.

3. Character selection apparatus according to claim 2, characterized in that the second computer is provided in the form of a server computer, and the plurality of first computers is provided in the form of a corresponding plurality of client computers.

4. Symbol definition apparatus including:
programmable electronic processing means;
dynamic display means operatively associated with or forming part of said programmable electronic processing means, said programmable electronic processing means being programmed to display an array of ideographic symbols selected according to the most likely next symbol or symbols to be required, and
a plurality of selection means operatively associated with or forming part of said programmable electronic processing means, said selection means being arranged in spatial relationship with one another and operable for selecting one or more symbols from said array, said array being arranged to mimic the spatial relationship of the selection means; and characterized in that:
said programmable electronic processing means, said dynamic display means, and said selection means are provided in the form of a first computer and data storage means operable for storing image data representing a plurality of images corresponding to said characters and selection data corresponding to a sequence of indicia belonging to a predetermined set of indicia for identifying each said character; said data storage means being provided in operative association with, and a strategy for selection of one or more of the characters for display being programmed into a second computer.

5. A method of selecting ideographic language symbols for input into symbol definition apparatus comprising a first computer having programmable electronic processing means, dynamic display means operably associated with or forming part of the programmable electronic processing means and selection means operably associated with or forming part of the programmable electronic processing means and a second computer having data storage means provided in operative association therewith and a strategy for selection of the characters for display being programmed therein, the method including:
programming the programmable electronic processing means to display an array of the ideographic symbols on a portion of the dynamic display means, the ideographic symbols being selected according to the most likely next symbols to be required; and
operating said selection means to select one or more symbols.

6. A method according to claim 5, and including displaying a new set of symbols on the dynamic display means for each further selection of the one or more ideographic symbols, providing a user again with the most likely next symbols for entry into, for example, a word processing document.

7. Software for selecting ideographic language symbols including:
a central processing module operable to control operation of the software;
a storage module operably associated with said central processing module and operable to store data relevant to a plurality of ideographic symbols;
a retrieval module operably associated with said central processing module and operable to retrieve data relevant to a selection of at least some of the ideographic symbols from said storage module;
a display module operably associated with the central processing module and operable to display said selection in the form of an array of ideographic symbols, and
a selection module operatively associated with said central processing module and operable to select one or more symbols from said array; and characterized in that:
said central processing module, said retrieval module, said display module and said selection module are provided in operative association with a first computer and said data storage module is provided in operative association with a second computer having programmed therein a strategy for selection of the characters for display.

8. Software according to claim 7, wherein the selection module is associated with selection means in the form of a keyboard, and the array is in the form of a mimic of the keyboard displayed on the dynamic display means.

9. Software according to claim 7, characterized in that the storage of the characters is centralized on a server computer, and the remainder of the software provided on one or more client computers operatively connectable to said server computer.

10. Character selection apparatus according to claim 1 wherein the ideographic language is Chinese and the keyboard is a standard keyboard having a QWERTY portion and a numeric keypad portion, and wherein the numeric keypad portion is provided with five alternative brush-stroke type categories as follows:
(1) any brush stroke written from left to right without turning, that is the “héng”; the “tí” or rising stroke is included in this category;
(2) any brush stroke written from top to bottom, that is the “shù”; basic strokes having hooks, that is, “shùg\overline{o}u” are included in this category;
(3) all left falling “pi\check{e}” strokes;
(4) all dots and the right falling “nà”; and
(5) all complicated “fùzá” or bent “zh\tilde{e}” strokes turning through more than one direction.

11. Character selection apparatus according to claim 10, wherein one or more keys in the QWERTY portion are programmed to provide for switching the keyboard to an entry device for Kana from the QWERTY portion of the keyboard, and back to Kanji.

12. Character selection apparatus according to claim 10, wherein one or more keys in the QWERTY portion are programmed to provide for switching the keyboard to an entry device for Hangul from the QWERTY portion of the keyboard, and back to Hanja.

13. Character selection apparatus according to claim 10, wherein one or more keys in the QWERTY portion are programmed to switch between “simplified” characters of the Peoples Republic of China and the “traditional” characters mainly used in Taiwan.

14. Character selection apparatus according to claim 10, wherein one or more keys in the QWERTY portion are programmed to switch to English or another syllabic language, including kana or hangul.

15. Apparatus for selecting symbols of an ideographic language including:
graphic data storage means for storing data representing graphic images of ideographic characters for the ideographic language;
character stroke data storage means for storing data representing stroke order of character strokes required to form said ideographic characters, said character strokes being categorised into a predetermined number of character stroke-type categories;
index means for indexing the data representing stroke order of character strokes against the data representing the graphic images;
display means for displaying one or more ideographic characters retrieved from said graphic data storage means;
character sub-element entry means for entering sub-elements of ideographic characters, said character sub-elements being in the form of said character stroke-type categories;
selection means for selecting one or more of the ideographic characters displayed by the display means;
processing means operatively connected to said graphic data storage means, said character stroke data storage means, said index means, said display means, said entry means and said selection means being operable to identify one or more characters within the character stroke data storage means on entry through the entry of ideographic stroke-type categories and the order in which the character strokes are entered through the entry designations, whereby one or more graphic representations of the ideographic characters indexed according to the character stroke order are retrieved from the corresponding character data storage means according to said index means and the graphic representation or representations are displayed by the display means for selection by said selection means; and characterized in that:
the processing means includes provision of undesignated strokes in the sequence of strokes, and being treated as “wildcards” whereby a user may select characters which are not precisely known to the user as to the correct stroke order and/or categories.

16. Apparatus according to claim 15, wherein the character is a Chinese writing character, and the sub-elements are the strokes from which the Chinese character is formed.

17. Apparatus according to claim 16, wherein the sub-elements are categorized according to stroke size and stroke form, and the indexing means include data relevant to the stroke size, stroke form, the initial direction of the writing strokes, the order in which the strokes are written to form the character, the number of strokes and data related to the frequency of usage of the character and character combinations forming words or phrases.
